(19) United States
(12) Patent Application Publication
(10) Pub. No.: US 2020/0231390 A1
(43) Pub. Date: Jul. 23, 2020

(54) PACK STACKER SYSTEM

(71) Applicant: LKC Solutions, LLC, Clive, IA (US)

(72) Inventor: Mike Allen Clayton, Adel, IA (US)

(21) Appl. No.: 16/745,659

(22) Filed: Jan. 17, 2020

Related U.S. Application Data
(60) Provisional application No. 62/794,089, filed on Jan. 18, 2019.

(51) Int. Cl. B65G 57/06; B65G 57/04; B65G 57/00; B65G 57/32

(52) U.S. Cl. CPC B65G 57/06; B65G 57/04; B65G 2203/0233; B65G 57/32; B65G 2201/0208; B65G 57/005

(57) ABSTRACT

A pack stacker system for stacking articles is presented. The pack stacker system is configured to lift an article from a conveyor while the conveyor is in operation and stack the article on a second article while the conveyor is in continuous operation. The pack stacker system is accurate and can operate without human intervention.

### CROSS REFERENCE TO RELATED APPLICATIONS

This application claims priority to U.S. Provisional Application No. 62/794,089 which was filed on Jan. 18, 2019 the entirety of which is incorporated herein fully by reference.

### FIELD OF THE DISCLOSURE

This disclosure relates generally to a pack stacker system. More specifically, and without limitation, this disclosure relates to a system for stacking articles in various configurations. More specifically and without limitation, this disclosure relates to a system for stacking a first article on top of a second article.

### BACKGROUND OF THE DISCLOSURE

A number of robotics and devices have been developed for use in factories and other assembly lines, including packaging lines. Common types of packaging systems include: case packing equipment, bottling equipment, fill and seal equipment, and labeling equipment. Each of these types of equipment and their respective configurations has unique benefits as well as unique advantages and drawbacks.

Case packing equipment is great for creating packaging, such as folding flat boxes into open containers. Another type of packaging equipment or perhaps a combo piece of case packaging equipment may go as far as taping or sealing one end of the box or package. Yet another function or piece of equipment might fill the box or carton. Still further down the line, an additional piece of case packaging equipment might fold and tape/seal the top of the box once the product has been placed within.

Furthermore, bottling equipment is another type of automated process available for mass production. Bottling equipment may fill a bottle, label a bottle and cap a bottle by the time the bottle reaches the end of a packaging line. Some bottling equipment may even group bottles and package them within a single box, such as a 6-pack. Furthermore, bottling equipment may even place four 6-packs within a larger cardboard box to be ready for shipping. There are many different types of assembly lines and manufacturing lines that tie into various types of lines and robotics available for shipping and packaging.

However, a lot of the equipment available in manufacturing and assembly lines are not adaptive for sensitive materials such as food products, soft packaging, or other products less common than boxes or bottles. There is an increasing need in the industry to be able to handle all of the various types of products which are either mass manufactured or desired to be mass packaged.

While many tools are available, a system capable of efficiently and effectively stacking an article on another article does not exist. Therefore, there is a need in the industry for a system which can rapidly and accurately stack an article on another article. Additionally, there is a need in the industry for a system which can sense the size of the articles it is stacking. This sensing would allow for a system to stack articles of varying sizes. Additionally, while speed is important, accuracy and handling is also just as critical. Therefore, there is also a need in the industry for a system which can accurately stack articles as well as stack articles with varying degrees of sensitivity or delicateness.

Furthermore, the type of human labor necessary to complete these packaging tasks is expensive and laborious. Assembly line work is very tedious and can be monotonous for humans. With time, this work becomes rigorous and therefore generates large turnover amongst employees as well as other problems. Therefore, there is a need in the art for a reliable, affordable, and efficient pack stacker system which can handle a wide range of products, not just boxes or bottles.

Another disadvantage of the current packaging and other assembly line style systems is that they require a large number of parts. Parts and other components of these machines can break or fail under rigorous applications, especially applications in an industrial setting. Thus, there is a need in the art for a system which requires fewer parts and a more robust working structure. A system with a more reliable structure would be able to last longer, especially on an assembly line, packaging, or in mass product production.

Another disadvantage of the current packaging and other assembly line style systems is that they require significant human intervention and monitoring. Current packaging systems and assembly line machines often fail or get clogged. Whether it is a box getting caught in the folding assembly or a jam, there is a need in the art for more automation which requires fewer human instances of intervention, and line shut down. Thus, a more effective machine with a single alarm of malfunction is needed in the art.

While a number of packaging and assembly line systems exist, none exist that are able to stack a first article on top of a second article. As one example of this application, a need exists in the art for a system which is able to stack one egg carton on top of another for packaging purposes without breaking the eggs inside the cartons.

As such, not only does a system which can stack articles on one another while the items are moving down an assembly line not exist, but there exist many problems with the packaging and assembly line systems and robotics in performing their respective functions. Finally, for all of these reasons, the industry needs a new system which can accomplish the tasks mentioned herein, among others, and be efficiently, safely, and reliably.

For the reasons stated above, and for other reasons stated below which will become apparent to those skilled in the art upon reading and understanding the specification, there is a need in the art for a pack stacker system which meets the needs of industry.

Thus it is a primary object of the disclosure to provide a pack stacker system that is efficient.

Yet another object of the disclosure is to provide a pack stacker system that is simple in design.

Another object of the disclosure is to provide a pack stacker system that is relatively inexpensive.

Yet another object of the disclosure is to provide a pack stacker system that is safe.

Another object of the disclosure is to provide a pack stacker system that is durable and robust.

Yet another object of the disclosure is to provide a pack stacker system that notifies the user when the system requires attention.

Another object of the disclosure is to provide a pack stacker system that reduces human interaction with the system.

Yet another object of the disclosure is to provide a pack stacker system that is capable of stacking one article on top of another article.

Another object of the disclosure is to provide a pack stacker system capable of stacking a first carton of eggs on top of a second carton of eggs.

Yet another object of the disclosure is to provide a pack stacker system that can stack articles both rapidly and accurately.

Another object of the disclosure is to provide a pack stacker system that can stack articles in alignment.

Yet another object of the disclosure is to provide a pack stacker system that can stack articles of varying sizes.

Another object of the disclosure is to provide a pack stacker system that can stack articles of varying sizes without human adjustment or intervention.

Another object of the disclosure is to provide a pack stacker system with the capability of stacking sensitive packages including, but not limited to, egg cartons.

Another object of the disclosure is to provide a pack stacker system which is already programmed to perform a particular function.

Yet another object of the disclosure is to provide a pack stacker system which can be quickly shut down.

Another object of the disclosure is to provide a pack stacker system which can sense when an object is ready to be stacked.

Yet another object of the disclosure is to provide a pack stacker system with a low-cost of ownership.

Another object of the disclosure is to provide a pack stacker system that works with conveyors and can be adapted to both large and small industrial settings.

Yet another object of the disclosure is to provide a pack stacker system that is easy to assemble and/or set-up.

Another object of the disclosure is to provide a pack stacker system that is easy to take down and or move.

Yet another object of the disclosure is to provide a pack stacker system that has a minimum number of parts.

Another object of the disclosure is to provide a pack stacker system that is simple to use. Yet another object of the disclosure is to provide a pack stacker system that is easy to use.

Another object of the disclosure is to provide a pack stacker system that is unique from any previously existing system.

Yet another object of the disclosure is to provide a pack stacker system that provides new capabilities to other functions previously being performed in the art.

Another object of the disclosure is to provide a pack stacker system that saves time.

These and other objects, features, or advantages of the present disclosure will become apparent from the specification and claims.

### BRIEF SUMMARY OF THE DISCLOSURE

The disclosure relates to a pack stacker system for stacking articles including, but not limited to, egg cartons, boxes, packages, cartons, cans, bottles, bags, tubs, cups, or other items that can be stacked. Furthermore, the disclosure relates to an adaptable system capable of sensing the size of articles and adjusting to these various sizes without human intervention or machine shut-off. The system includes a stand which supports a stacker. The stacker is capable of lifting articles and accurately stacking them on other articles.

Disclosed is an example of a pack stacker system. In one nonlimiting example, the pack stacker system includes a stacker having a lift, an arm controller, and a pair of opposing arms. In this nonlimiting example embodiment the lift is configured to vertically raise and lower the arm controller and the pair of opposing arms, the arm controller is configured to control the pair of opposing arms to move horizontally towards and away from each other to capture and release an article. In this nonlimiting example embodiment, the system further includes a stand supporting the stacker, a sensor configured to trigger movement of the pair of opposing arms and the lift, and a control cabinet housing a pneumatic system and a control system, wherein the pneumatic system and the control system are configured to provide pressurized air to the lift and the arm controller.

Disclosed is a nonlimiting example of a method of stacking a first article on a second article. In this nonlimiting example, the method includes the steps of: moving the first article into a stand; lowering a pair of arms towards the first article; sandwiching the first article between the pair of arms by moving the pair of arms towards one another; lifting the first article; moving the second article into the stand; lowering the pair of arms to place the first article on the second article; and moving the pair of arms away from one another to release the first article.

Disclosed is an example of a pack stacker system. In this nonlimiting example, embodiment, the pack stacker system includes a stand comprised of at least two vertical posts, a conveyer passing through the at least two vertical posts, a stacker having a lift controller and an arm controller, the lift controller being configured to control a lift cylinder, the arm controller being configured to control a pair of opposing arms, wherein the lift cylinder is configured to raise and lower the arm controller and the pair of opposing arms and the arm controller is configured to move the pair of opposing arms towards and away from each other, and a sensor configured to trigger movement of at least one of the pair of opposing arms and the lift.

### BRIEF DESCRIPTION OF THE DRAWINGS

The figures depict one or more embodiments of a pack stacker system.

FIG. 1 is a view of a system in accordance with an example embodiment;

FIG. 2 is a side view of the system in accordance with the example embodiment;

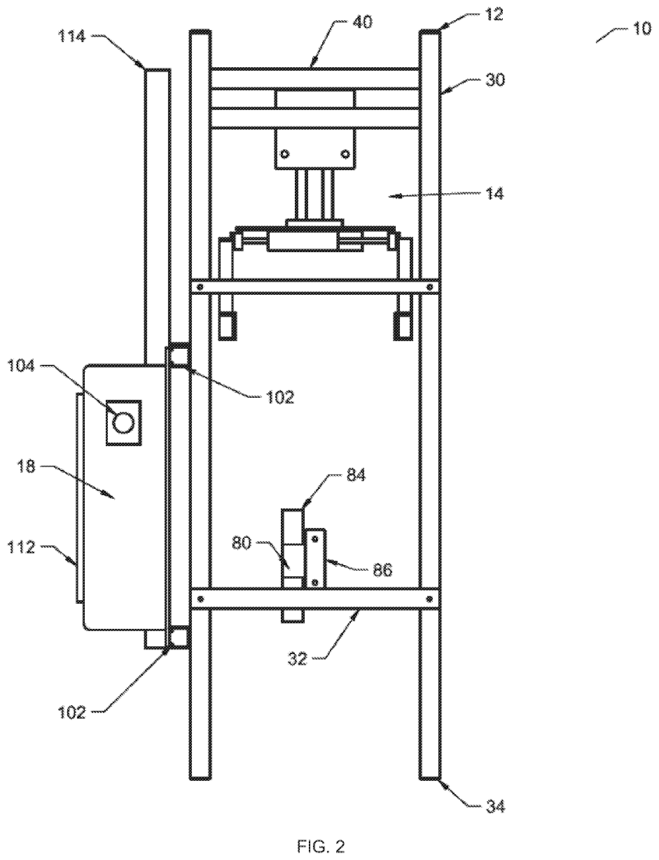

FIG. 3 is another side view of the system in accordance with the example embodiment;

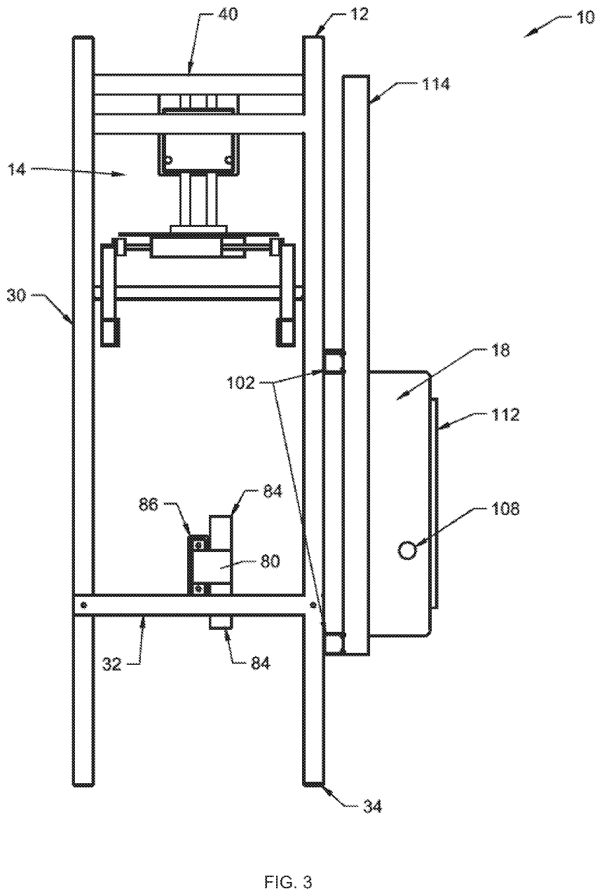

FIG. 4 is another side view of the system in accordance with the example embodiment;

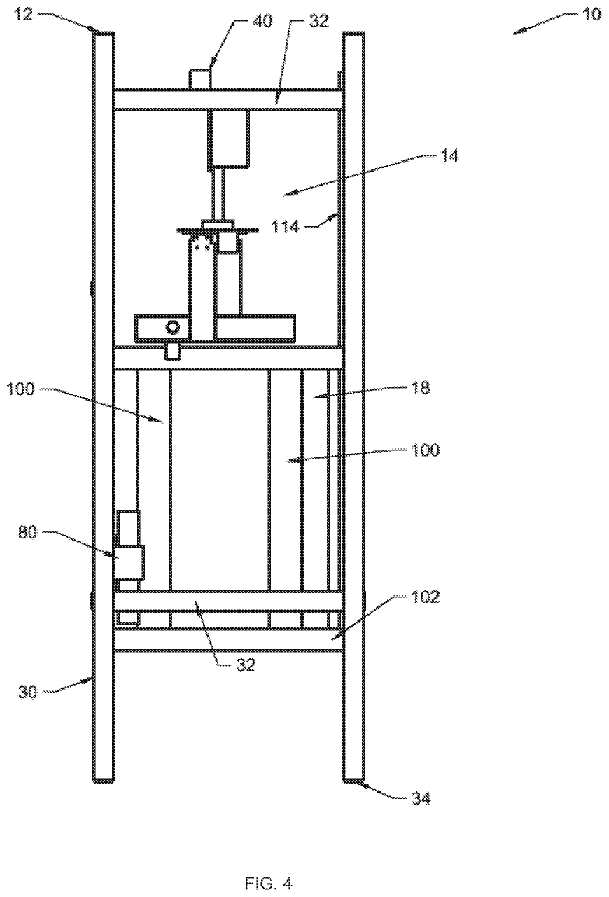

FIG. 5 is another side view of the system in accordance with the example embodiment;

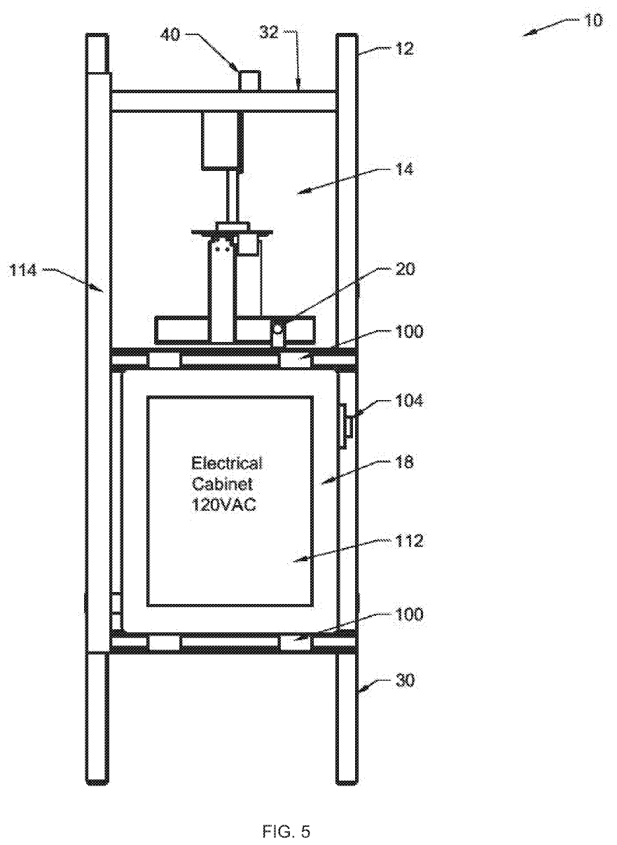

FIG. 6 is a top view of the system in accordance with the example embodiment;

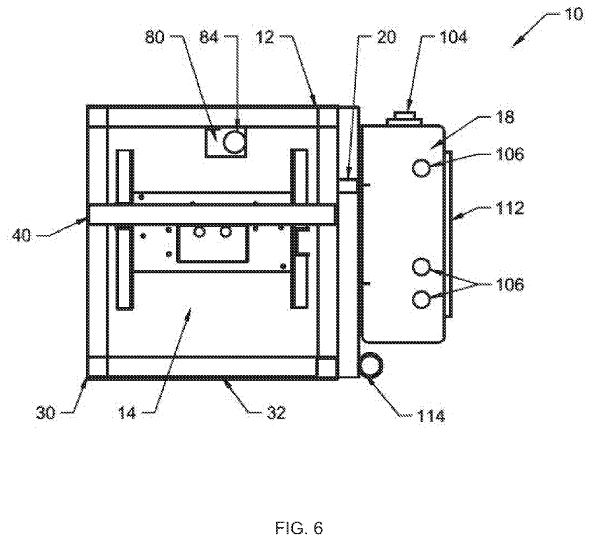

FIG. 7 is a bottom view of the system in accordance with the example embodiment;

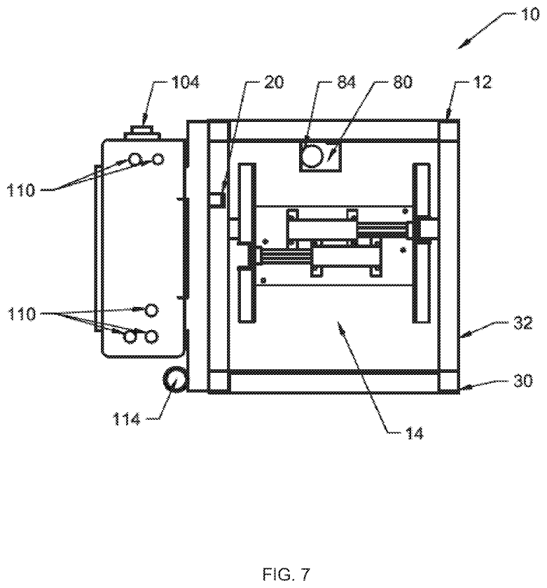

FIG. 8 is a first perspective view of the system in accordance with the example embodiment;

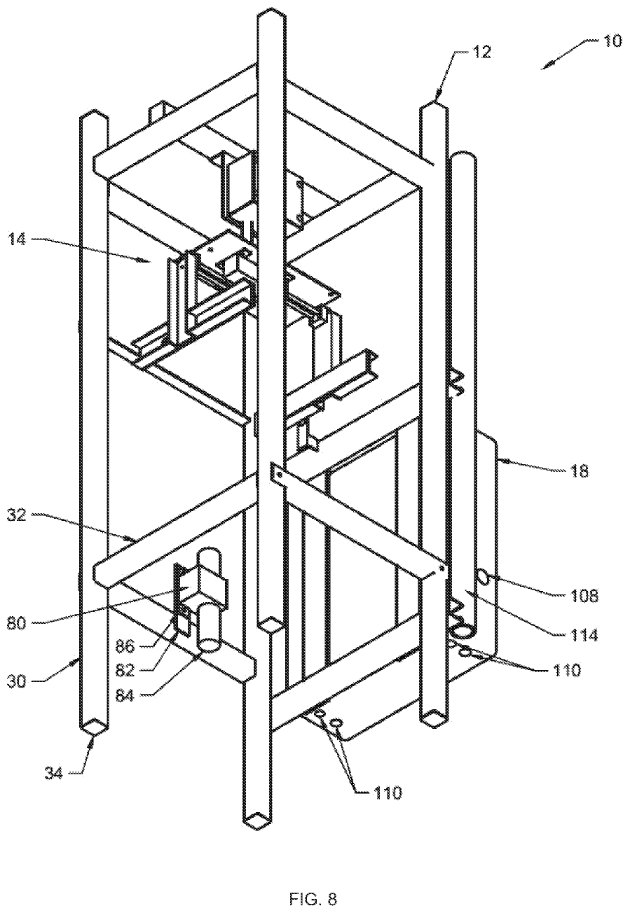

FIG. 9 is an exploded view of a stacker in accordance with the example embodiment;

FIG. 10 are views of the stacker of the system in accordance with the example embodiment;

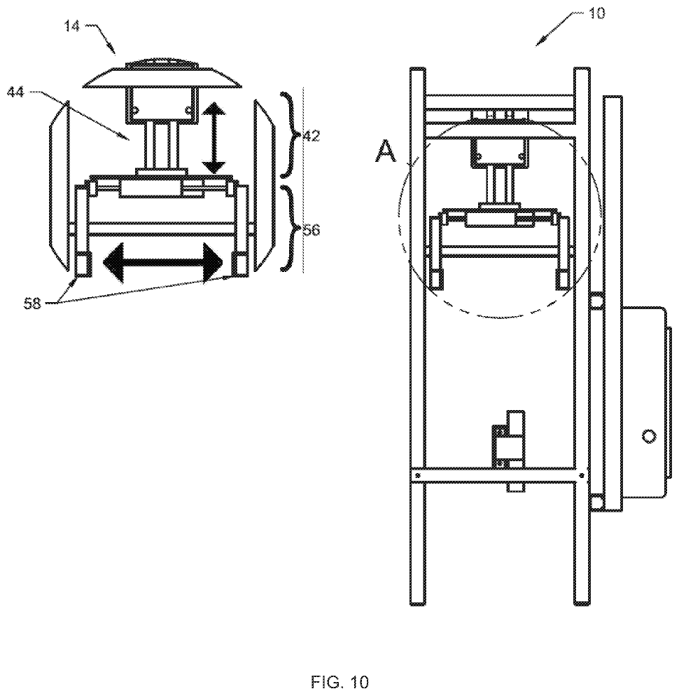

FIG. 11 is a view of a pneumatic system in accordance with the example embodiment;

FIG. 12A is a view of a control system in accordance with the example embodiment;

FIG. 12B is a view of a control system in accordance with the example embodiment;

FIG. 13 is a view of a control cabinet in accordance with the example embodiment;

FIG. 14 is a view of the system and a conveyor in accordance with the example embodiment; and

FIG. 15 is another view of the system and a conveyor in accordance with the example embodiment.

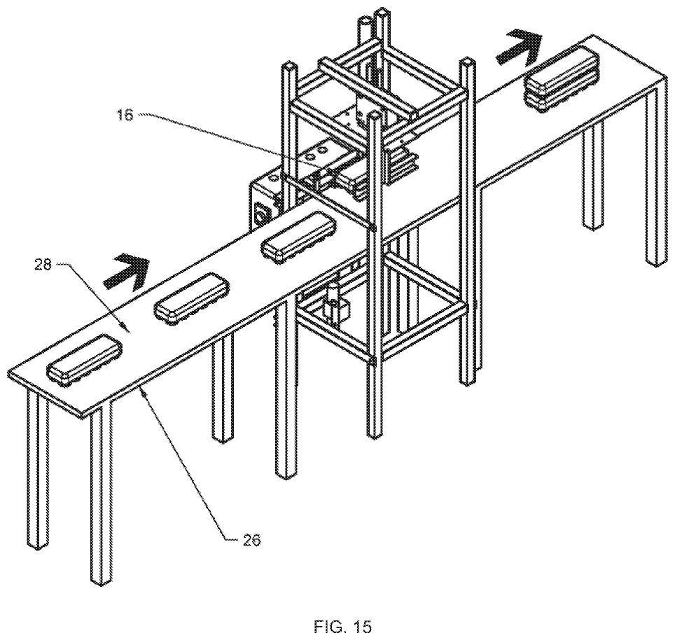

### DETAILED DESCRIPTION

In the following detailed description of the embodiments, reference is made to the accompanying drawings which form a part hereof, and in which is shown by way of illustration specific preferred embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the present disclosures. The following detailed description is, therefore, not to be taken in a limiting sense, and the scope of the present disclosure is defined only by the appended claims, along with the full scope of equivalents to which such claims are entitled.

As used herein, the terminology such as vertical, horizontal, top, bottom, front, back, end and sides are referenced according to the views presented. It should be understood, however, that the terms are used only for purposes of description, and are not intended to be used as limitations. Accordingly, orientation of an object or a combination of objects may change without departing from the scope of the disclosure.

### Pack Stacker System

### System:

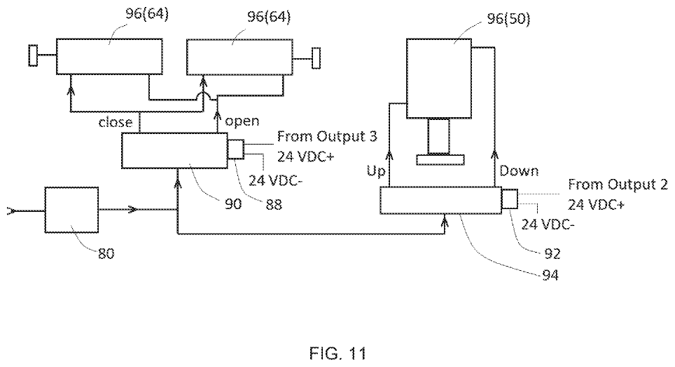

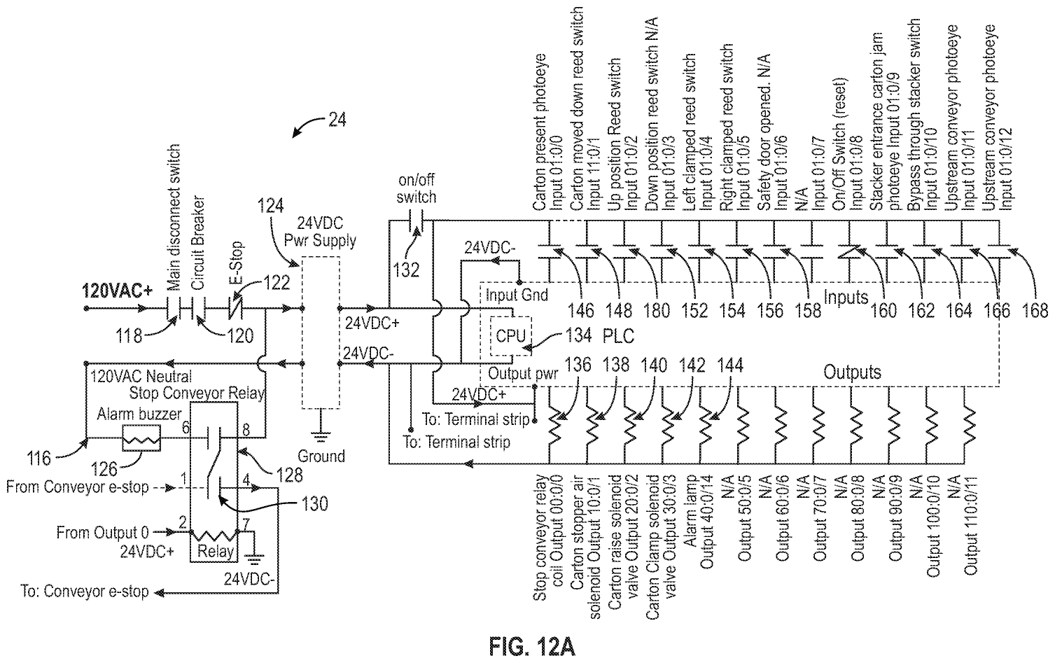

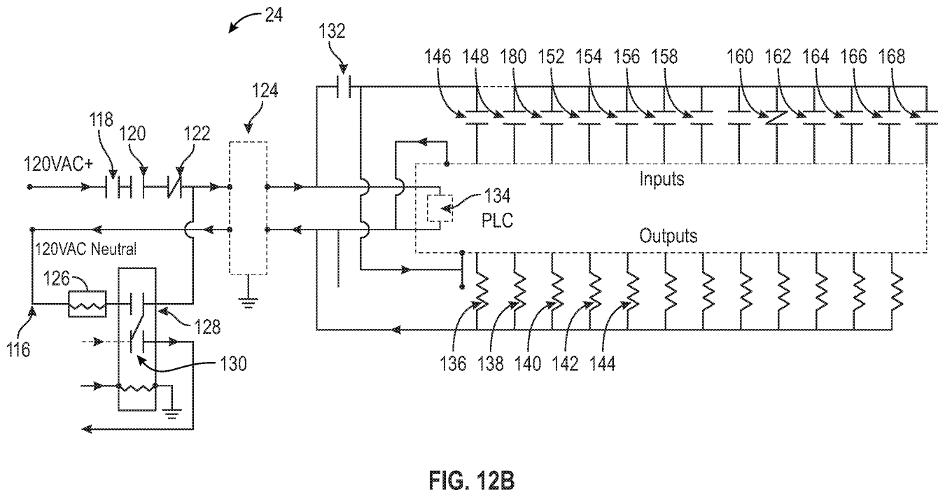

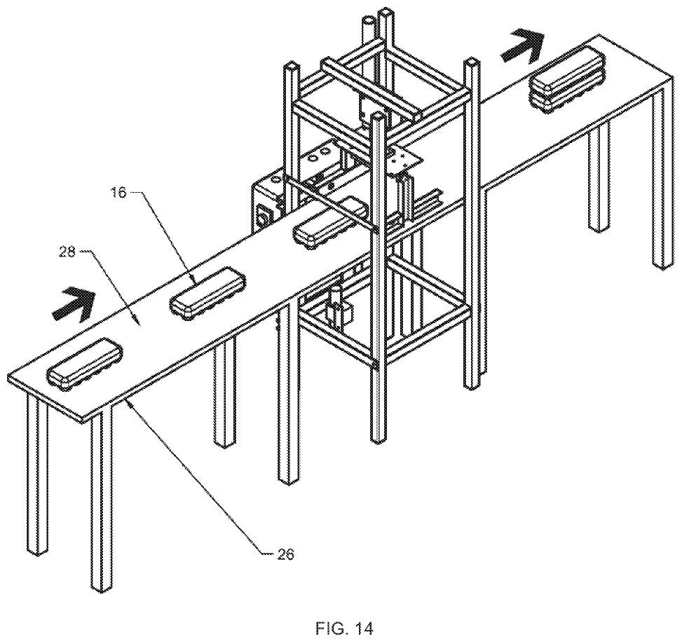

With reference to the figures, a pack stacker system 10 (or simply “system 10”) is presented. System 10 is formed of any suitable size, shape and design and is configured to facilitate in the safe, efficient, and reliable stacking of articles 16 (see at least FIG. 14) in a quick, easy, safe, accurate, and proficient manner. In the arrangement shown, as one example, the pack stacker system 10 may have the following components: a stand 12, a stacker 14, at least one article 16, a control cabinet 18, a plurality of sensors 20, a pneumatic system 22 (see at least FIG. 11), a control system 24 (see at least FIG. 12), and may include at least one conveyor 26 (see at least FIG. 14), among other components.

### Stand:

As noted above, the pack stacker system 10 includes, in addition to other components, a stand 12. Stand 12 is formed of any suitable size, shape, and design and is configured to support stacker 14 above a conveyor 26 while also accommodating the conveyor 26. In the arrangement shown, as one example, stand 12 and is configured to facilitate the operation of stacker 14. In the arrangement shown, as one example, stand 12 includes at least one post 30, at least one lintel 32, may include at least one foot 34, and may include at least one handle, among other components.

In the arrangement shown, as one example, stand 12 is configured to facilitate in the stacking and packing of at least one article 16. Stand 12 is configured to be moved around on rollers, wheels, or any other arrangement which may facilitate in movement of stand 12 from one location to another. Additionally, stand 12 may be stationary with at least one conveyor 26 moving through stand 12.

In the arrangement shown, as one example, stand 12 is formed of steel. However, any other material which is adequate for forming stand 12 is hereby contemplated for use. Other materials include, but are not limited to, hollow tube, polymers, enhanced polymers, other metal materials, composites, or any combination thereof. Manufactured metals or rolled steels have the benefits of being strong and durable. One disadvantage of using steel for stand 12 may be the weight of the steel. Therefore, it may be beneficial to contemplate a strengthened polymer or other composite materials that are lighter than steel yet durable. These alternative materials are hereby contemplated for use in both stand 12 and throughout system 10.

Post: In the arrangement shown, as one example, stand 12 includes at least one post 30. Post 30 is formed of any suitable size, shape, and design and is configured to provide support to the various other components of system 10. Post 30 may or may not be hollow. In one arrangement, as one example, post 30 is formed of a hollow tube which is square in shape. In another arrangement, as one example, post 30 is formed of a hollow tube which is circular in shape. As yet another example, post 30 may be fabricated having a C-Section, an H-section, or an I-section. In the arrangement shown, as one example, stand 12 includes four posts 30 located on each corner of stand 12, spaced horizontally from one another and running vertically in a parallel spaced relation to one another. The posts 30, in the arrangement shown, as one example, extend vertically from a top end to a bottom end and provide a length upon which other features of the disclosure can be placed. The arrangement shown, as one example, includes four posts 30; however, any other number of posts 30 is hereby contemplated for use, including one post 30, two posts 30, three posts 30, five posts 30, and more. Furthermore, post 30 may be formed of any material without departing from the scope of the disclosure. In one arrangement, as one example, post 30 may be formed of metal, plastic, and the like.

Lintel: In the arrangement shown, as one example, stand 12 includes at least one lintel 32. Lintel 32 is formed of any suitable size, shape, and design and is configured to provide support to the various components of system 10. Lintel 32 may or may not be hollow. In one arrangement, as one example, lintel 32 is formed of a hollow tube which is square in shape. In another arrangement, as one example, lintel 32 is formed of a hollow tube which is circular in shape. As yet another example, lintel 32 may be fabricated having a C-Section, an H-section, or an I-section. In the arrangement shown, as one example, stand 12 includes two lintels 32 running from a length extending from one post 30 to another post 30. The lintels 32 are located in a vertically spaced relation to one another. In the arrangement shown, as one example, a lower lintel 32 provides attachment and support near the lower end of the posts 30, while an upper lintel 32 provides attachment and support near the upper end of the posts 30. The arrangement shown, as one example, includes eight lintels 32, however, any other number of lintels 32 is hereby contemplated for use, including one lintel 32, two lintels 32, three lintels 32, four lintels 32, and more.

In the arrangement shown, as one example, stand 12 includes posts 30 and lintels 32 which make up a stabilized unit or plurality of stabilized units that are able to support the components of the system 10. However, stand 12 may also be a single unit or material which supports the other components of the system 10 and helps the other components of the system 10 complete the operations to which they are designed for. As one example, but not limiting this disclosure to, stand 12 may be a single, solid base, or a base with wall structures, or a base with a smooth outer structure, or a base with a structure and a single arm extending upward to support the other features of this disclosure. In other words, stand 12 may be made of a single, unitary piece or a plurality of pieces. Any other arrangement, or configuration of a stand 12, which supports the features of this disclosure is hereby contemplated for use.

Foot: In some applications of system 10, it is important that stand 12 be flat, level and stable. To ensure a level and stable stand 12, the lower end of each post 30 may include a foot 34 that may be adjustable. As stated above, system 10 may comprise any number of posts 30 without departing from the scope of the disclosure. Furthermore, in one arrangement, as one example, each post 30 of the system 10 may comprise a foot 34 at the lower end of the post 30. As a result, system 10 may comprise any number of feet 34 without departing from the scope of the disclosure. These adjustable feet 34 allow the length of posts 30 to be adjusted so as to accommodate for variations in the factory or packaging warehouse floors, or in other locations where the system 10 is used. This ensures that a flat, level and stable stacking environment is created for system 10. In one arrangement, foot 34 is threaded into the lower end of post 30 so that adjustment may be easily made by simply rotating foot 34.

The foot 34 may be formed of any material without departing from the scope of the disclosure. In one arrangement, as one example, foot 34 may be formed of any type of material including, but not limited to, plastic, metal, non-metal materials, rubber, polyvinyl chloride (PVC), or any other type of material. Additionally, foot 34 may be formed of any size, shape or design without departing from the scope of the disclosure. In one arrangement, as one example, foot 34 are square or rectangular in shape. Furthermore, foot 34 may also include a traction pad in order to facilitate in stable positioning of stand 12. The traction pad may be comprised of rubber, fabric, felt, textured metal, plastic, etc. without departing from the scope of the disclosure. Additionally, the traction pad may be formed of any size, shape or design without departing from the scope of the disclosure.

Throughout the disclosure, reference to foot 34 refers to each foot 34 individually, unless the disclosure specifically states that it is referring to only a specific foot 34.

Handle: In one arrangement, as one example, lintels 32 provide for a naturally occurring handle of the system 10. In another arrangement, system 10 may comprise a handle. In one arrangement, as one example, system 10 may comprise a handle in addition to the lintels 32. In an alternative arrangement, system 10 may comprise a handle instead of lintels 32. Any number of handles may be utilized by system 10 without departing from the disclosure. Also, handles may be made of any material including, but not limited to, metal, plastic, fiberglass, etc., without departing from the scope of the disclosure. One or more handles may be included in system 10 and positioned at various locations around stand 12 to facilitate in moving or repositioning stand 12.

### Stacker:

The pack stacker system 10 may comprise, in addition to other components, a stacker 14. Stacker 14 is formed of any suitable size, shape, and design and is configured to facilitate in the safe stacking of an article 16 (see at least FIG. 14) in a quick, easy, accurate and reliable manner. Furthermore, stacker 14 may be formed of any material without departing from the scope of the disclosure. For example, stacker 14 may be formed of plastic, metal, non-metal material, and PVC. In the arrangement shown, as one example, stacker 14 includes the following components: a stacker support 40, a lift 44, and a pair of opposing arms 58, among other components.

Stacker Support: The stacker 14 includes, in addition to other components, a stacker support 40. The stacker support 40 is formed of any suitable size, shape, and design and is configured to support the stacker 14 above conveyor 26. In the arrangement shown, as one example, stacker support 40 is configured as a cross-bar extending a length from one supporting lintel 32 nearer the top side of stand 12 to a second supporting lintel 32 on the opposite side of stand 12. However, any other arrangement of the stacker support 40 is hereby contemplated for use.

In the arrangement shown, as one example, stacker support 40 is formed of steel. However, any other material which is adequate for forming a stacker support 40 is hereby contemplated for use. Other materials include, but are not limited to polymers, enhanced polymers, other metal materials, composites, or any combination thereof. Manufactured metals or rolled steels have the benefits of being strong and durable. One disadvantage of using steel for the stacker support 40 may be the weight of the steel. Therefore, it may be beneficial to contemplate a strengthened polymer or other composite materials that are lighter than steel yet durable. These alternative materials are hereby contemplated for use in the stacker support 40.

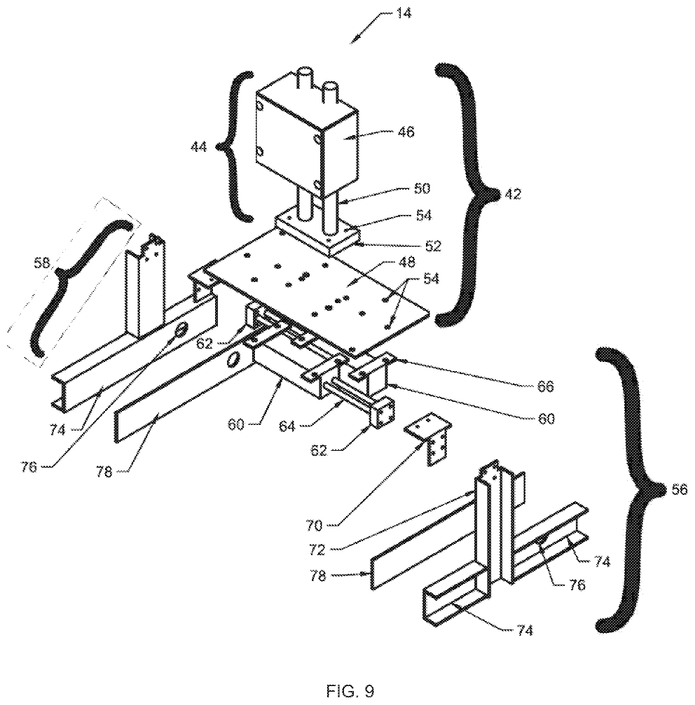

Additionally, in the arrangement shown, as one example, stacker support 40 is formed of steel, which makes drilling holes or other calibration features 54 (see at least FIG. 9) more difficult. Therefore, it may be advantageous to use a softer material requiring less unique tools which are capable of providing attachment points or other calibration features 54 on the stacker support 40.

Calibration Features: In the arrangement shown, as one example, stacker support 40 includes one or more calibration features 54. Calibration features 54 are formed of any suitable size, shape and design and are configured to facilitate alignment and calibration of stacker support 40 to stand 12. Additionally, in the arrangement shown, as one example, calibration features 54 are configured to facilitate the attachment of the stacker 14 to the stacker support 40. Furthermore, calibration features 54 of stacker support 40 are formed of any type of material including, but not limited to, plastic, metal, non-metal materials, rubber, or any other type of material.

In the arrangement shown, as one example, stacker support 40 suspends the stacker 14 into the middle, upper section of stand 12. However, other arrangements of the stacker support 40 may include variations of cross-bracing, or a mechanical arm which is capable of suspending the stacker 14 or lifting the stacker 14, as well as spinning the stacker 14. These other variations of the arrangement give the stacker 14 added mobility and versatility which may be desired in the factory setting for both ease of use and functionality. These variations of the stacker support 40 and stacker support 40 arrangements are hereby contemplated for use.

Lift: The pack stacker system 10 includes, in addition to other components, a lift 44 (see at least FIG. 9) which forms the upper portion 42 of stacker 14. Lift 44 is formed of any suitable size, shape, and design and is configured to vertically lift an article 16 positioned on the conveyor 26. In the arrangement shown, as one example, lift 44 forms the upper portion 42 of stacker 14 and includes the following components: a lift controller 46, a lift plate 48, a lift cylinder 50, a lift attachment 52, and calibration features 54, among other components.

In the arrangement shown, as one example, lift 44 forms the upper portion 42 of stacker 14 and is configured to move the lower portion 56 of the stacker 14 vertically in an up and down motion, as is shown in the example. In the arrangement shown, as one example, lift 44 includes a lift controller 46, among other components. In the arrangement shown, as one example, lift controller 46 houses a solenoid valve 90 (see at least FIG. 11) and a coil 88 which enables the lift 44 to control the lift cylinder 50. In the arrangement shown, as one example, the solenoid valve 90 is operatively connected to the lift cylinder 50 to extend the lift cylinder 50 a length downward when the solenoid valve 90 is activated. In the arrangement shown, as one example, the solenoid valve 90 is operatively connected to the lift cylinder 50 to move the lift cylinder 50 upward when the solenoid valve 90 is de-activated.

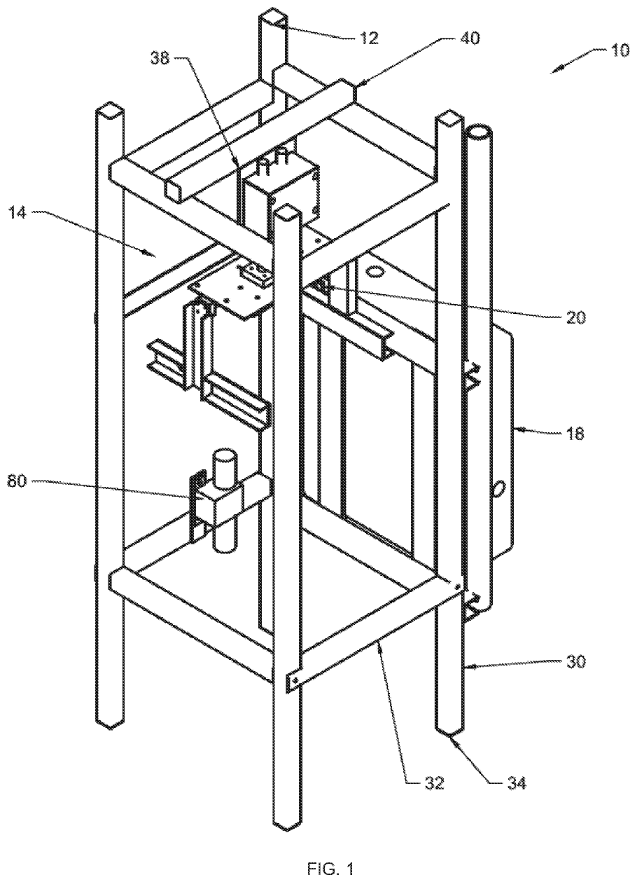

Lift Controller: Lift 44 includes one or more lift controllers 46, among other components. Lift controller 46 is formed of any suitable size, shape, and design and is configured to facilitate in raising and lowering the lower portion 56 of the stacker 14. In the arrangement shown, as one example, lift controller 46 is attached to the lift controller plate 38 (see at least FIG. 1) which is attached to the stacker support 40. In the arrangement shown, as one example, lift controller 46 is box-like in shape having a top, a bottom, a front, a back, and opposing sides. In the arrangement shown, as one example, the lift controller 46 houses the solenoid valve 90 and the coil 88 within the hollow interior of the lift controller 46. In the arrangement shown, as one example, at least one lift cylinder 50 extends downward and out of the lift controller 46. In the arrangement shown, as one example, the lift controller 46 is designed to move the lift cylinder 50 in and out of the lift controller 46 in an upward and downward motion. In the arrangement shown, as one example, the coil 88 causes the solenoid valve 90 to activate or deactivate.

Lift Cylinder: Lift controller 46 includes one or more lift cylinders 50, among other components. Lift cylinder 50 is formed of any suitable size, shape, and design and is configured to facilitate in raising and lowering the lower portion 56 of the stacker 14. In one arrangement, as one example, lift cylinders 50 are circular, square, or rectangular in shape. However, any other shape or configuration is hereby contemplated for use. Furthermore, the lift cylinder 50 may be formed of any type of material including, but not limited to, plastic, metal, non-metal materials, rubber, polyvinyl chloride (PVC), or any other type of material. Also, the lift cylinder 50 may be referred to as a lift cylinder 50, at least one lift cylinder 50, or lift cylinders 50, etc. without departing from the disclosure.

In the arrangement shown, as one example, lift controller 46 includes two lift cylinders 50 which extend a length through the entirety of the lift controller 46, extending out of the bottom of the lift controller 46 as well as through the top of the lift controller 46. Any number of lift cylinders 50 may be utilized by the lift controller 46 without departing from the scope of the disclosure. For example, the lift controller 46 may comprise one, two, three, four, five, six, seven, eight, nine, ten, or more lift cylinders 50 depending on the application of system 10.

Lift Attachment: Lift 44 includes one or more lift attachments 52, among other components. Lift attachment 52 is formed of any suitable size, shape, and design and is configured to facilitate the attachment and calibration of the lift cylinders 50 to the lower portion 56 of the stacker 14, and the pair of opposing arms 58. In one arrangement, as one example, lift attachments 52 are circular, square, or rectangular in shape. However, any other shape or configuration is hereby contemplated for use. Furthermore, lift attachment 52 may be formed of any type of material including, but not limited to, plastic, metal, non-metal material, rubber, polyvinyl chloride (PVC), or any other type of material. Also, the lift attachment 52 may be referred to as a lift attachment 52, at least one lift attachment 52, or lift attachments 52, etc. without departing from the disclosure.

In the arrangement shown, as one example, lift attachment 52 is attached to the lower end of lift cylinders 50. In the arrangement shown, as one example, the lift attachment 52 has a top, a bottom, a front, a back, and a pair of opposing sidewalls. Additionally, in the arrangement shown, as one example, lift attachment 52 has a set of pre-drilled holes or calibration features 54. In the arrangement shown, as one example, the top, flat surface of the lift attachment 52 is attached to the bottom side of lift cylinders 50. In the arrangement shown, as one example, the lift attachment 52 provides a means for connecting the lift 44 to the lower portion 56 of the stacker 14.

Calibration features of the lift attachment: In the arrangement shown, as one example, lift attachment 52 includes one or more calibration features 54. Calibration features 54 are formed of any suitable size, shape and design and are configured to facilitate alignment and calibration of the lift attachment 52 with the lift plate 48. Furthermore, calibration features 54 of the lift attachment 52 are formed of any type of material including, but not limited to, plastic, metal, non-metal materials, rubber, or any other type of material. Also, the calibration features 54 may be referred to as a calibration feature 54, at least one calibration feature 54, or calibration features 54, etc. without departing from the disclosure.

In the arrangement shown, as one example, a plurality of calibration features 54 are positioned on the lift attachment 52 as well as the lift plate 48. The calibration features 54 of the lift attachment 52, along with other components, facilitate in calibration of the stacker 14 as well as the assembly and dis-assembly of system 10.

Lift Plate: Lift 44 includes a lift plate 48, among other components. Lift plate 48 is formed of any suitable size, shape, and design and is configured to facilitate the attachment and calibration of the lift attachment 52 to the lower portion 56 of the stacker 14, including the arm controllers 60. In the arrangement shown, as one example, the lift plate 48 is slender and rectangular in shape with a top, a bottom, and sidewalls. Furthermore, lift plate 48 may be formed of any type of material including, but not limited to, plastic, metal, non-metal materials, or any other type of material. In the arrangement shown, as one example, the lift plate 48 is attached to the bottom side of the lift attachment 52, where the top side of the lift plate 48 and the bottom side of the lift attachment 52 are in flush engagement with one another.

In the arrangement shown, as one example, the lift plate 48, is much wider than lift attachment 52, extends a length from a first end to a second end and is much deeper than lift attachment 52 extending a length from a front end to a back end, when viewed from the top. In other words, the lift plate 48, in the arrangement shown, as one example, is much more flat in appearance with a lesser distance from the top to the bottom than the lift attachment 52. Therefore, the lift attachment 52, in the arrangement shown, as one example, is taller than the lift plate 48 when viewed from the side, which gives the lift attachment 52 a more box-like appearance than the flattened, plate-like appearance of the lift plate 48. Additionally, in the arrangement shown, as one example, the lift plate 48 comprises a set of calibration features 54.

Calibration features of the lift plate: In the arrangement shown, as one example, lift plate 48 includes one or more calibration features 54. Calibration features 54 are formed of any suitable size, shape and design and are configured to facilitate alignment and calibration of the lift plate 48 with the lift attachment 52. Furthermore, calibration features 54 of the lift plate 48 are formed of any type of material including, but not limited to, plastic, metal, non-metal materials, rubber, or any other type of material.

In the arrangement shown, as one example, a plurality of calibration features 54 are positioned extending through the lift plate 48 as well as in the lift attachment 52. The calibration features 54 of the lift plate 48, along with other components, facilitate in calibration of the stacker 14 as well as the assembly and dis-assembly of the system 10.

Throughout the disclosure, reference to calibration features 54 refers to calibration features 54 of the lift attachment 52, calibration features 54 of the lift plate 48, calibration features 54 of the arm plate 66, etc., unless the disclosure specifically states that it is referring to only a specific calibration feature 54. Also, the calibration features 54 may be referred to as a calibration feature 54, at least one calibration feature 54, or calibration features 54, etc. without departing from the disclosure.

Arms: The system 10 includes, in addition to other components, a pair of opposing arms 58. The pair of opposing arms 58 is formed of any suitable size, shape, and design and is configured to clamp an article 16 between them in order to apply an amount of pressure which facilitates in gripping the article 16. In one arrangement, the pair of opposing arms 58 is formed of two arms which are opposed to one another. One arm of the pair of opposing arms 58 is shaped and configured so as to extend lift 44 and provide the side to side, or lateral, engagement and disengagement of the stacker 14. Furthermore, a single arm of the pair of opposing arms 58 is shaped generally an elongated, slender member extending downward and attached to a horizontal elongated, slender member configured to squeeze, clamp, or grip an article 16. However, any other shape or configuration is hereby contemplated for use. Furthermore, the pair of opposing arms 58 may be formed of any type of material including, but not limited to, plastic, metal, non-metal materials, rubber, polyvinyl chloride (PVC), or any other type of material.

In the arrangement shown, as one example, the pair of opposing arms 58 forms the lower portion 56 of stacker 14 and includes the following components: an arm controller 60, an arm attachment 62, an arm cylinder 64, an arm plate 66, an arm assembly 68, an arm spacer 70, an upper arm 72, a lower arm 74, a photo eye 76, and a grip 78, among other components. However, any other shape, configuration, or components are hereby contemplated for use.

In the arrangement shown, as one example, the pair of opposing arms 58 forms the lower portion 56 of stacker 14 and is configured to move the lower portion 56 of stacker 14 horizontally in a side to side motion which causes the arm assembly 68 to move toward one another or to spread apart. In the arrangement shown, as one example, this function allows the arm assembly 68 to grip an article 16 so the article 16 may be lifted or so that the article 16 may be stacked.

Arm Plate: Pair of opposing arms 58 includes one or more arm plates 66, among other components. Arm plates 66 are formed of any suitable size, shape, and design and are configured to facilitate the attachment and calibration of the arm controllers 60 to the lift plate 48 and thus, the stacker 14. In one arrangement, as one example, arm plates 66 are circular, square, or rectangular in shape. However, any other shape or configuration is hereby contemplated for use. Furthermore, the arm plates 66 may be formed of any type of material including, but not limited to, plastic, metal, non-metal materials, rubber, polyvinyl chloride (PVC), or any other type of material. Also, the arm plates 66 may be referred to as an arm plate 66, arm plates 66, a plurality of arm plates 66, etc. without departing from the disclosure.

In the arrangement shown, as one example, the arm plate 66 is attached to the top of the arm controller 60. In the arrangement shown, as one example, the arm plate 66 has a top, a bottom, a front, a back, and a pair of sides. In the arrangement shown, as one example, the top, flat surface of the arm plate 66 is attached to the bottom, flat surface of the lift plate 48. In the arrangement shown, as one example, the arm plate 66 provides a means for connecting the lower portion 56 of the stacker 14 to the lift 44.

In the arrangement shown, the pair of opposing arms 58 comprises four arm plates 66 which facilitate the connection of the arm controllers 60 to the lift plate 48. In the arrangement shown, as one example, a single arm configuration of the pair of opposing arms 58 would have two arm plates 66 which facilitate the connection of a single arm controller 60 to the lift plate 48. However, any other number of arm plates 66, is hereby contemplated for use, including one, two, three, or more arm plates 66. Additionally, in the arrangement shown, as one example, the arm plate 66 has a set of pre-drilled holes or calibration features 54.

Calibration features of the arm plate: In the arrangement shown, as one example, arm plates 66 include one or more calibration features 54. Calibration features 54 are formed of any suitable size, shape and design and are configured to facilitate alignment and calibration of the arm plate 66 with the lift plate 48. Furthermore, calibration features 54 of an arm plate 66 are formed of any type of material including, but not limited to, plastic, metal, non-metal materials, rubber, or any other type of material.

In the arrangement shown, as one example, a plurality of calibration features 54 are positioned along the arm plate 66 of the arm controllers 60. The calibration features 54 of the arm plates 66, along with other components, facilitate in calibration of the stacker 14 as well as the assembly and dis-assembly of the system 10.

Arm Controller: The pair of opposing arms 58 includes one or more arm controllers 60. Arm controller 60 is formed of any suitable size, shape, and design and is configured to facilitate opening or closing the arm assemblies 68. In the arrangement shown, as one example, arm controller 60 is attached to the lift plate 48 which is attached to the lift attachment 52. In the arrangement shown, as one example, arm controller 60 is box-like in shape having a top, a bottom, a front, a back, and opposing sides. Furthermore, arm controller 60 is formed of any type of material including, but not limited to, plastic, metal, non-metal materials, rubber, or any other type of material.

In the arrangement shown, as one example, the pair of opposing arms 58 comprises two arm controllers 60. Furthermore, in the arrangement shown, as one example, a single arm of the pair of opposing arms 58 comprises a single arm controller 60 configured to laterally move the single arm assembly 68. However, any other number of arm controllers 60 which is needed for the proper configuration and application of the system 10 is hereby contemplated for use including one, two, three, four, or more arm controllers 60 depending on the application of the system 10.

Arm Cylinder: As provided above, stacker 14 comprises arm cylinders 64, among other components. In the arrangement shown, as one example, arm controller 60 houses a solenoid valve 90 and a coil 88 in the hollow interior of each arm controller 60, which enables the pair of opposing arms 58 to be controlled by the arm cylinders 64. Arm cylinders 64 are formed of any suitable size, shape, and design. In one arrangement, as one example, arm cylinders 64 are tubular in shape. However, any other shape or configuration is hereby contemplated for use. Furthermore, the arm cylinders 64 may be formed of any material including, but not limited to, plastic, metal, non-metal materials, rubber, polyvinyl chloride (PVC), or any other type of material. Also, throughout the disclosure, the arm cylinders 64 may be referred to as an arm cylinder 64, arm cylinders 64, at least one arm cylinder 64, etc. without departing from the disclosure.

In the arrangement shown, as one example, the solenoid valve 90 is operatively connected to the arm cylinder 64 to extend the arm cylinder 64 a length outward from the arm controller 60 when the solenoid valve 90 is activated. In the arrangement shown, as one example, the solenoid valve 90 is operatively connected to the arm cylinder 64 to move the arm cylinder 64 inward toward the arm controller 60 when the solenoid valve 90 is deactivated. In the arrangement shown, as one example, the coil 88 causes the solenoid valve 90 to activate or deactivate.

Arm Attachment: Pair of opposing arms 58 includes one or more arm attachments 62, among other components. Arm attachment 62 is formed of any suitable size, shape, and design and is configured to facilitate the attachment and calibration of the arm cylinders 64 to the arm assemblies 68. In the arrangement shown, as one example, the arm attachment 62 has a top, a bottom, a front, a back, and a pair of attachment walls. In one arrangement, as one example, arm attachment 62 is circular, square, or rectangular in shape. However, any other shape or configuration is hereby contemplated for use. Furthermore, arm attachment 62 may be formed of any type of material including, but not limited to, plastic, metal, non-metal materials, rubber, polyvinyl chloride (PVC), or any other type of material.

In the arrangement shown, as one example, the arm attachment 62 is attached to the end of the arm cylinders 64 as well as the arm spacer 70 and the upper arm 72 of the arm assembly 68. In other words, in the arrangement shown, as one example, the attachment surface of the arm attachment 62 is attached to the interior portion of the arm spacer 70, which is attached to the upper arm 72. In the arrangement shown, as one example, the arm attachment 62 provides a means for connecting the arm cylinders 64 to the arm assemblies 68. Additionally, in the arrangement shown, as one example, the arm attachment 62 has a set of pre-drilled holes or calibration features 54.

Calibration features of the arm attachment: In the arrangement shown, as one example, arm attachment 62 includes one or more calibration features 54. Calibration features 54 are formed of any suitable size, shape and design and are configured to facilitate alignment and calibration of the arm attachment 62 with the arm assembly 68. Furthermore, calibration features 54 of the arm attachment 62 are formed of any type of material including, but not limited to, plastic, metal, non-metal materials, rubber, or any other type of material.

The calibration features 54 of the arm attachment 62, along with other components, facilitate in calibration of the arm controller 60 and the stacker 14, as well as the assembly and dis-assembly of the system 10.

Arm Spacer: Pair of opposing arms 58 includes one or more arm spacers 70, among other components. Arm spacer 70 is formed of any suitable size, shape, and design and is configured to facilitate the attachment and calibration of the arm cylinders 64 to the arm assemblies 68. In one arrangement, as one example, arm spacers 70 are circular, square, or rectangular in shape. In the arrangement shown, as one example, arm spacer 70 is formed of an upper edge at a ninety degree angle with a side edge. These two edges, and formation of the arm spacer 70, in the arrangement shown, facilitate in stabilizing the pair of opposing arms 58, which is necessary in the handling of delicate articles at high speeds. However, any shape or configuration is hereby contemplated for use. Furthermore, the arm spacers 70 may be formed of any type of material including, but not limited to, plastic, metal, non-metal materials, rubber, polyvinyl chloride (PVC), or any other type of material.

Additionally, in the arrangement shown, as one example, the arm spacer 70 facilitates the attachment of the upper arm 72 to the arm attachment 62. Also, the arm spacers 70 may be referred to as an arm spacer 70, at least one arm spacer 70, arm spacers 70, etc. without departing from the disclosure.

Calibration features of the arm spacer: In the arrangement shown, as one example, arm spacer 70 includes one or more calibration features 54. Calibration features 54 are formed of any suitable size, shape and design and are configured to facilitate alignment and calibration of the arm spacer 70 with the arm attachment 62. Furthermore, calibration features 54 of the arm spacer 70 are formed of any type of material including, but not limited to, plastic, metal, non-metal materials, rubber, or any other type of material.

In the arrangement shown, as one example, a plurality of calibration features 54 are positioned on the arm spacer 70 as well as on the arm attachment 62. The calibration features 54 of the arm spacer 70, along with other components, facilitate in calibration of the arm spacer 70 and the stacker 14, as well as the assembly and dis-assembly of the system 10.

Upper Arm: Among other components, the pair of opposing arms 58 includes one or more upper arms 72. In other words, in the arrangement shown, as one example, each single arm of the pair of opposing arms 58 has a single upper arm 72. Upper arm 72 is formed of any suitable size, shape, and design and is configured to provide support to the lower arm 74 and grip 78 while providing an extension a length downward so that an article 16 can be stacked. In one arrangement, as one example, upper arm 72 is a formed of an elongated c-shape metallic tube which extends a length from the arm spacer 70 nearer the top of the arm assembly 68 downward to the lower arm 74. Upper arm is configured to provide an extension and support for lower arm 74. Furthermore, in the arrangement shown, as one example, upper arm 72 is a length which allows for an article 16 to slide below the stacker 14 and be engaged by the lower arm 74 while still on the belt 28 of the conveyor 26. Said another way, upper arm 72 is a length which allows the lower arm 74 to engage the article 26, but still lift the article from the conveyor 26. However, any other shape or configuration is hereby contemplated for use. In the arrangement shown, as one example, upper arm 72 extends a length from its upper end, where it connects to the arm spacer 70, and its lower end where it is connected to the lower arm 74. Furthermore, upper arm 72 may be formed of any type of material including, but not limited to, plastic, metal, non-metal materials, rubber, polyvinyl chloride (PVC), or any other type of material. Also, the upper arm 72 may be referred to as an upper arm 72, upper arms 72, a plurality of upper arms 72, etc. without departing from the disclosure.

In the arrangement shown, as one example, upper arm 72 is comprised of a particular length which is suitable for the intended operation of system 10. However, upper arm 72 may be any length which is necessary for the handling of articles 16 of varying heights and sizes. In the arrangement shown, as one example, upper arm 72 is formed of rolled or molded steel, which creates an interior wall attached at its edges to a pair of opposing sidewalls. However, upper arm 72 may be formed of any suitable and durable material and may be hollow on the interior. In the arrangement shown, as one example, upper arm 72 and lower arm 74 are formed of a solid, welded or molded piece. However, the upper arm 72 and lower arm 74 may be formed of two or more pieces wherein upper arm 72 and lower arm 74 are then connected together by a means. Having a separate upper arm 72 and lower arm 74 may be advantageous in the art because the lower arm 74 could be changed in and out to adjust to different articles or functions. Additionally, the lower arm 74 could be changed out after ware while leaving the upper arm 72 in position. For these and other reasons, it may be beneficial to have separate pieces of an upper arm 72 and a lower arm 74; however, an upper arm 72 and lower arm 74 being formed of a single piece is hereby contemplated for use.

Calibration features of the upper arm: In the arrangement shown, as one example, upper arm 72 includes one or more calibration features 54. Calibration features 54 are formed of any suitable size, shape and design and are configured to facilitate alignment and calibration of the upper arm 72 with the arm attachment 62. Furthermore, calibration features 54 of the upper arm 72 are formed of any type of material including, but not limited to, plastic, metal, non-metal materials, rubber, or any other type of material.

In the arrangement shown, as one example, a plurality of calibration features 54 are positioned on the upper arm 72. The calibration features 54 of the upper arm 72, along with other components, facilitate in calibration of the upper arm 72 and the stacker 14, as well as the assembly and dis-assembly of the system 10.

Lower Arm: Pair of opposing arms 58 includes one or more lower arms 74, among other components. In the arrangement shown, each single arm of the pair of opposing arms 58 includes a single lower arm. Furthermore, each single lower arm 74 may be formed of multiple pieces. Lower arm 74 is formed of any suitable size, shape, and design and is configured to clamp an article 16. In the arrangement shown, as one example, lower arm 74 extends a length from a first end to a second end. In one arrangement, as one example, lower arm 74 is a formed of an elongated c-shape metallic tube which extends a length. In the arrangement shown, as one example 74, lower arm is formed of two c-shaped metallic tubes attached to each side, in a horizontal configuration, to the lower end of upper arm 72. In the arrangement shown, as one example, lower arm 74 also includes a photoeye 76. However, any other shape or configuration is hereby contemplated for use. Furthermore, lower arm 74 may be formed of any material including, but not limited to, plastic, metal, non-metal materials, rubber, polyvinyl chloride (PVC), or any other type of material.

In the arrangement shown, as one example, the lower arm 74 is comprised of a particular length which is suitable for the intended operation of system 10. However, other lengths for various operations and for use with various articles 16 are hereby contemplated for use. In the arrangement shown, as one example, lower arm 74 is attached to stacker 14 via the upper arm 72. In the arrangement shown, as one example, upper arm 72 is attached to the lower arm 74 at roughly the middle point between the first end and the second end of the lower arm 74. However, other attachment locations are hereby contemplated for use.

In the arrangement shown, as one example, lower arm 74 is comprised of a particular width which is suitable for the intended operation of the system 10. However, lower arm 74 may be any width which is necessary for the handling of articles 16 of varying heights and sizes. In the arrangement shown, as one example, lower arm 74 is formed of rolled or molded steel using an interior wall attached at its edges to a pair of opposing sidewalls. However, lower arm 74 may be formed of any suitable and durable material and may or may not be hollow on the interior.

In the arrangement shown, as one example, upper arm 72 and lower arm 74 are formed of a solid, welded or molded piece. However, the upper arm 72 and lower arm 74 may be formed of two or more pieces wherein upper arm 72 and lower arm 74 are then connected together by a means. Having a separate upper arm 72 and lower arm 74 may be advantageous in the art because the lower arm 74 could be changed in and out to adjust to different articles or functions. Additionally, the lower arm 74 could be changed out after ware while leaving the upper arm 72 in position. For these and other reasons, it may be beneficial to have separate pieces of an upper arm 72 and a lower arm 74; however, a single piece is hereby contemplated for use.

Photoeye: In the arrangement shown, as one example, lower arm 74 also includes a photoeye 76. Photoeye 76 may be any suitable size, shape, and design and provides an opening in order to provide the sensor 20 with a clear path of detection. In one arrangement, as one example, the sensor 20 will detect size, distance, and other parameters of articles 16. In the arrangement shown, as one example, photoeye 76 is a small circular opening located on the lower arm 74. However, other locations, sizes, and variations of the photoeye 76 are hereby contemplated for use including, but not limited to, the photoeye 76 being positioned on the upper arm 72 or the size of the photoeye 76 being amended.

Grip: Pair of opposing arms 58 includes one or more grips 78, among other components. Grip 78 is formed of any suitable size, shape, and design and is configured to provide a special surface to clamp an article 16. In one arrangement, as one example, grip 78 is square or rectangular in shape. However, any other shape or configuration is hereby contemplated for use.

Grip 78 may be formed of any type of material including, but not limited to, plastic, metal, non-metal materials, rubber, polyvinyl chloride (PVC), or any other type of material. In the arrangement shown, as one example, grip 78 is made of a malleable material which is softer and more giving than steel. In the arrangement shown, as one example, grip 78 is able to provide some give or indentation. In other words, in the example shown, grip 78 allows the arm assembly 68 to have a certain level of cushion or give. Additionally, in the arrangement shown, as one example, grip 78 may have an adherence like quality which allows the arm assembly 68 to have an advantageous and more delicate hold on an article 16.

In the arrangement shown, as one example, grip 78 extends a length from a first end to a second end. In the arrangement shown, as one example, the grip 78 is formed of a particular length for a specific operation and covers approximately the entire interior surface of the lower arm 74. However, other lengths and various operations for use with various articles 16 are hereby contemplated for use. In the arrangement shown, as one example, grip 78 is attached to the lower arm 74 via an adhesive. However, any other attachment means and attachment locations are hereby contemplated for use. For example, a grip 78 may also be attached to the upper arm 72.

In the arrangement shown, as one example, grip 78 also includes a photoeye 76. As provided above, the photoeye 76 provides an opening in order to provide the sensor 20 with a clear path of detection. In one arrangement, as one example, the sensor 20 will detect the size, distance, and other parameters of articles 16. In the arrangement shown, as one example, photoeye 76 is a small circular opening located on the grip 78. However, other locations, sizes, and variations of the photoeye 76 are hereby contemplated for use, such as, locating the photoeye 76 a grip 78 on the upper arm 72 or changing the size of the photoeye 76. In the arrangement shown, as one example, the location of the photoeye 76 for the grip 78 and the photoeye 76 for the lower arm 74 should be in alignment in order for the sensor 20 to be able to detect the presence and features of an article 16.

In the arrangement shown, as one example, grip 78 is formed of a thickness which is suitable for a particular operation of the system 10. However, grip 78 may be formed of any thickness which is necessary for the handling of articles 16 of varying shapes and sizes. In the arrangement shown, as one example, grip 78 is formed of a rubber material and an adhesive. However, other materials which would facilitate in the gripping operation of an article 16 are hereby contemplated for use including, but not limited to, foam or polymers. Additionally, grip 78 may be formed of varying thicknesses at varying locations across the length of the grip 78 in order to increase the effectiveness of handling articles 16 of odd shapes or textures.

Alternative Embodiment (Suction): In an alternative embodiment, the stacker 14 does not comprise a lower portion 56, but instead only has an upper portion 42. In this alternative embodiment, the upper portion 42 of the stacker 14 is equipped with a suction cup or other means to attach to and/or grab the article 16.

Alternative Embodiment (Arms Only): In an alternative embodiment, the stacker 14 does not comprise a lift 44. In this alternative embodiment, the stacker 14 may consist of only a pair of opposing arms 58 that holds the article 16 while a conveyor 26 lowers or drops. In yet another arrangement, a single arm 58 may push article 16 off of the conveyor 26 into a holder location within the system 10 that is lower than or equal to the top level of the conveyor 26. Subsequently, a single arm or arms 58 would push a second article 16 onto the first article 16 before releasing the second article 16. Alternatively, the stacked articles 16 may be lifted from the holder location and pushed or placed back on the conveyor 26.

### Article:

The system 10 comprises, in addition to other components, an article 16. Article 16 is formed of any suitable size, shape, and design. In the arrangement shown, as one example, system 10 is configured to stack articles 16. In one arrangement, as shown, system 10 comprises a first article 16 and a second article 16 wherein the first article 16 is accurately and efficiently stacked on the second article 16 as the articles 16 enter and exit system 10 by means of a conveyor 26. While a first article 16 is shown being stacked on a second article 16, any number of articles 16 is hereby contemplated without departing from the disclosure. Throughout the disclosure, reference to an article 16 refers to a first article 16, unless the disclosure specifically states otherwise.

In the arrangement shown, as one example, article 16 is an egg carton. However, any other article 16 is hereby contemplated for use. Examples of articles 16 include, but are not limited to, cardboard boxes, bottles, packages of bottles, cans, packages of cans, food items, other grocery items, electronic or mechanical equipment, and other materials which require efficient stacking, especially articles 16 which may be sensitive to gripping. Examples of articles 16 which might be sensitive to gripping include egg cartons, loaves of bread, and glass articles, among other fragile articles or arrangements of articles 16.

### Control Cabinet:

The system 10 includes, in addition to other components, a control cabinet 18. Control cabinet 18 is formed of any suitable size, shape, and design and is configured to house pneumatic system 22 as well as a control system 24. In the arrangement shown, as one example, control cabinet 18 has a main body with a top, a bottom, a front, a back, and opposing sides. Control cabinet 18 is generally square or rectangular in shape. However, any other shape or configuration is hereby contemplated for use. Control cabinet 18 also includes a cabinet plate 100, a cabinet support 102, a power switch 104, a plurality of switches 106, a buzzer 108, openings 110, a door 112, and a conduit 114, among other components. In the arrangement shown, as one example, control cabinet 18 is box-like in shape with a door 112 located on its front that provides access to the systems inside.

In the arrangement shown, as one example, control cabinet 18 includes a cabinet support 102. Cabinet support 102 is formed of any size, shape, and design and is configured to attach the control cabinet 18 to stand 12. In one arrangement, as one example, cabinet support 102 is square or rectangular in shape. However, any other shape or configuration is hereby contemplated for use. Furthermore, any number of cabinet supports 102 may be utilized by the control cabinet 18 without departing from the disclosure. For example, the control cabinet 18 may comprise one, two, three, four, five, six, seven, eight, nine, ten, or more cabinet supports 102 depending on the application of the system 10. In the arrangement shown, as one example, cabinet support 102 comprises two elongated steel bars which are attached by welding to stand 12. Additionally, the cabinet supports 102 are bolted to the control cabinet 18. However, other methods of attachment of the cabinet support 102 to stand 12 and or to the control cabinet 18, such as, screwing, welding, bolting, adhering or other attachment means are hereby contemplated for use.

In the arrangement shown, as one example, control cabinet 18 includes a power switch 104. Power switch 104 is formed of any suitable size, shape, and design and is configured to function as the main on/off switch for system 10. In the arrangement shown, as one example, power switch 104 is a circular push button located on the side, in open view and for easy access, of the control cabinet 18. In this arrangement, power switch 104 is hard-wired to the control system 24 housed within the control cabinet 18. However, other means of a power switch 104 such as remote switching or control from a mobile device are also considered. These other arrangements of a power switch 104 are not hard wired but would include an antenna, a receiver or transceiver, and processor mounted to a PC board within the housing of control cabinet 18. Furthermore, other embodiments of a hard-wired power switch 104 such as a lever or emergency pull switch are hereby contemplated for use.

In the arrangement shown, as one example, control cabinet 18 includes a plurality of switches 106. Plurality of switches 106 are formed of any suitable size, shape and design and are configured to provide control of variables of system 10. In the arrangement shown, as one example, plurality of switches 106 are located along the side of control cabinet 18 and are formed of hard-wired push buttons which are easily accessible for a user so a user may make real-time adjustments or changes to the functioning of system 10 while system 10 is in operation. In an alternative arrangement to a plurality of switches 106, these functions may be controlled remotely by a mobile device or computer. In yet another alternative arrangement, a capacitive touch screen may exist on the outside surface of control cabinet 18 or be mounted on stand 12 that allows a user to make real-time changes to system 10. Some changes a user may want to make include, but are not limited to, the speed of operation of the system 10, the depth of operation of the lift 44, or the width of operation of the pair of opposing arms 58.

In the arrangement shown, as one example, control cabinet 18 includes openings 110. Openings 110 are formed of any suitable size, shape and design and are configured to provide a path for wires and other cords, including pneumatic tubes, to enter and exit the interior of the control cabinet 18. In the arrangement shown, as one example, openings 110 are located along the bottom of the control cabinet 18 and allow for wires and other cords to exit the control cabinet 18 and enter the adjoining conduit 114.

Conduit: The control cabinet 18 includes, in addition to other components, an adjoining conduit 114. Conduit 114 is formed of any suitable size, shape and design and is configured to protect wire and other cords. In the arrangement shown, as one example, conduit 114 is a hollow pipe with a hollow interior wide enough to hold all the necessary and required cords so as to not cause interference of electrical signals amongst the wires and to allow for required National Electric Code ratings when it comes to wire conductance and signal interference within a conduit.

Pneumatic System: The system 10 includes, in addition to other components, a pneumatic system 22. Pneumatic system 22 is formed of any suitable size, shape and design and is configured to move other components of system 10 at exactly the time which the other components of system 10 need to be activated so as to efficiently and accurately stack articles 16.

In the arrangement shown, as one example, a majority of the components of the pneumatic system 22 are housed within the control cabinet 18. However, a number of components, from the pneumatic tubes carrying pressurized and regulated air to the solenoid valves that activate the air pressured cylinders, are outside of the control cabinet 18. Thus, pneumatic system 22 may be in any form necessary to carry out the functions of stacking articles 16 and is not limited to the components housed within the control cabinet 18.

In the arrangement shown, as one example, control cabinet 18 houses the components of pneumatic system 22 necessary to conduct the operations of system 10, including but not limited to, a PC board, a memory, a microprocessor, and possibly an antenna for transmitting signals. These controllers are capable of receiving signals from the control system 24 and activating electric signals to activate other components of the pneumatic system 22 including, but not limited to, the solenoid valves 90 of the arm controllers 60, the solenoid valve 94 of the lift controllers 46, and sending appropriate amounts of air to and from the regulator 80.

Regulator: In the arrangement shown, as one example, pneumatic system 22 includes a regulator 80. In the arrangement shown, as one example, regulator 80 is not housed within the control cabinet 18 but is attached to stand 12. Regulator 80 is formed of any suitable size, shape and design and is configured to control and enhance air pressure to a desired output pressure. Regulators are well known in the art and are used for gases and liquids. In the arrangement shown, as one example, regulator 80 is designed to regulate the air pressure that comes from the pneumatic system 22, and after transforming air pressure, regulator 80 applies appropriate air pressure to components of system 10. In addition to internal components, regulator 80 includes a regulator support 82, a plurality of regulator conduits 84, and a regulator attachment 86.

Regulator Support, Regulator Attachment, and Regulator Conduit: In the arrangement shown, as one example, regulator 80 includes a regulator support 82. Regulator support 82 is formed of any suitable size, shape and design and is configured to support the regulator 80 and attach regulator 80 to stand 12. In the arrangement shown, as one example, regulator 80 includes a regulator attachment 86. Regulator attachment 86 is formed of any suitable size, shape and design and is configured to attach the regulator 80 to regulator support 82. In the arrangement shown, as one example, regulator support 82 and regulator attachment 86 work in harmony to attach regulator 80 to stand 12 for safe and efficient operation. In the arrangement shown, as one example, regulator 80 also includes a regulator conduit 84. Regulator conduit 84 is formed of any suitable size, shape and design and is configured to house tubes and wires of pneumatic system 22.

In the arrangement shown, as one example, an air pressure of 30 psi is regulated by the regulator 80. However, any other psi range is contemplated for use in system 10 and with varying article 16 types, as is hereby contemplated because the system 10 may be used for a variety of articles 16 and may need variations on the air pressure.

### Control System:

The system 10 includes, in addition to other components, a control system 24. Control system 24 is formed of any suitable size, shape, and design and is configured to facilitate all operations and movement of system 10. Control system 24 includes a programmable logic controller (PLC) 98 (which may be the same as PLC 134 of FIGS. 12A and 12B), which are well known in the art for use with assembly lines. In the arrangement shown, as one example, control system 24 may include the following components: a sensor 20, wires 116, a main disconnect switch 118, a circuit breaker 120, an emergency stop 122, a power supply 124, an alarm buzzer 126, a stop conveyor relay 128, a conveyor emergency stop 130, an on/off switch 132, a CPU 134, a stop conveyor relay coil 136, a stop conveyor relay solenoid 138, an article raise solenoid valve 140, an article clamp solenoid valve 142, an alarm lamp 144, an article present sensor 146, an article move down switch 148, an up position switch 150, a down position switch 152, an arm 1 clamped switch 154, an arm 2 clamped switch 156, a safety door open switch 158, an on/off switch reset 160, an entrance jam sensor 162, a bypass switch 164, a first upstream conveyor sensor 166, a second upstream conveyor sensor 168, and software, among other components.

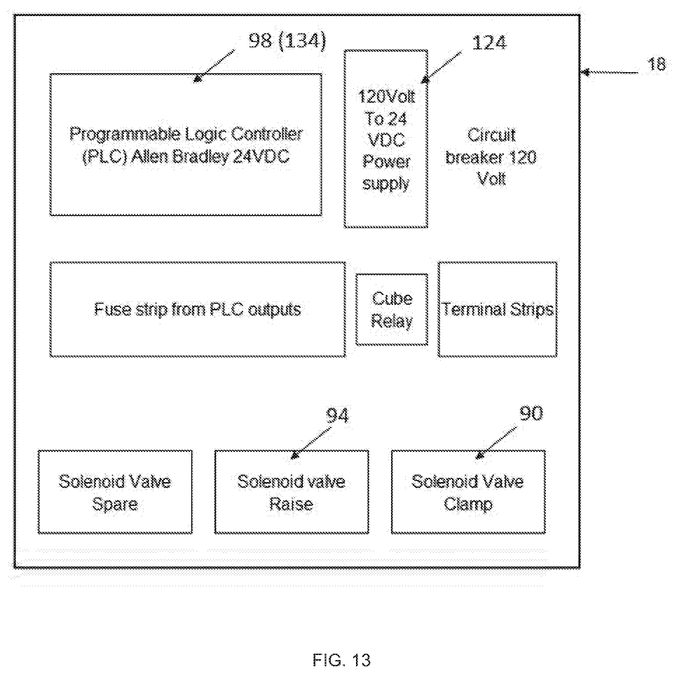

Sensor: The control system 24 includes, in addition to other components, a sensor 20. Sensor 20 is formed of any suitable size, shape and design and is configured to sense the presence of an article 16. Sensor 20 sends a signal to PLC 98 (see at least FIG. 13) when an article 16 is detected. Depending on the relay positions of the control system 24, the PLC 98 will make decisions based on the code language. Any number of sensors 20 may be utilized by the control system 24 without departing from the disclosure. For example, the control system 24 may comprise one, two, three, four, five, six, seven, eight, nine, ten, or more sensors 20 depending on the application of the system 10. In the arrangement shown, the PLC 98 incorporates information detected by the sensor 20 in a manner which provides for efficient, accurate, and swift stacking of articles 16.

### Conveyor:

The 10 may include, in addition to other components, a conveyor 26. Conveyor 26 is formed of any suitable size, shape, and design and is configured to move articles 16 through stand 12. In the arrangement shown, as one example, conveyor 26 is piece of mechanical handling equipment capable of moving article 16 from one location to another in a quick and efficient manner. In the arrangement shown, as one example, conveyor 26 is a belt conveyor system which includes a belt 28 and at least one pulley.

In the arrangement, shown as one example, the belt 28 is configured to loop around and engage the at least one pulley 36. In the arrangement shown, as one example, the at least one pulley 36 is operatively connected to a drive element which causes the pulley 36 to rotate, in turn causing the belt 28 to form an endless loop of carrying medium that rotates about the at least one pulley 36. In this arrangement, as is shown, the belt 28 along the top side of the loop moves in a programmed direction, carrying with it any materials or articles 16 placed upon it.

In the arrangement shown, as one example, conveyor 26 loops through the interior section of stand 12. In other words, the conveyor 26 moves through the interior of stand 12 below the stacker 14 such that stacker 14 can access articles 16 positioned on the conveyor 26. Thus, the loop of the conveyor 26 moves through stand 12 between the posts 30.

In one arrangement, as shown, a belt conveyor 26 is utilized in the system 10. However, any type of conveyor 26 is hereby contemplated for use including, but not limited to, a gravity conveyor, a chain conveyor, a wire mesh conveyor, a bucket conveyor, a flexible conveyor, a pneumatic conveyor, a belt driven roller conveyor, and the like.

### In Operation:

In the arrangement shown, as one example, the system 10 comprises the steps necessary for stacking articles 16. These steps are described herein. The first article 16 is placed on a conveyor 26. The first article 16 is moved forward on the conveyor 26 along the path of the conveyor 26. When the first article 16 enters the interior of stand 12, the sensor 20 detects the presence of the first article 16. The presence of the first article 16 triggers activation of the stacker 14.

After the stacker 14 is triggered, lift 44 lowers the lower portion 56 of stacker 14 into approximate engagement with the belt 28. In the arrangement shown, as one example, lift 44 lowers the pair of opposing arms 58 to a height such that the pair of opposing arms 58 can engage the first article 16. In the arrangement shown, as one example, the lift 44 lowers the pair of opposing arms 58 so as to bring the bottom of the lower arm 74 approximately in flush engagement with the belt 28 of the conveyor 26. In the arrangement shown, however, lower arm 74 of the pair of opposing arms 58 does not come into contact with the belt 28.

Once lift 44 engages the lower portion 56 of the stacker 14, the pair of opposing arms 58 is engaged. The pair of opposing arms 58 is mechanically moved towards one another in a motion which causes the article 16 to be compressed between the pair of opposing arms 58. This compression force on the lateral sides of the article 16, caused by the pair of opposing arms 58, is sufficient to lift the article 16. Once a preset distance of movement by the pair of opposing arms 58 is complete, the pair of opposing arms 58 stops their inward movement as they have clamped the article 16.

Once the article 16 is clamped, the lift 44 returns to a disengaged position, which raises the pair of opposing arms 58 vertically. Thus, the article 16 is lifted off the belt 28 of the conveyor 26 a set distance. In the arrangement shown, as one example, the belt 28 of the conveyor 26 is in constant motion throughout the process. The continuous movement of the belt 28 is advantageous as it allows for continuous operation of the system 10 which leads to increased production and less down time. The continuous movement of the belt 28 is also advantageous because it is less strenuous on the components of the conveyor 26, as repeated starting and stopping would cause the pulley 36 and belt 28 to develop stresses in the material which leads to breaking.

With the first article 16 lifted off of the conveyor 26, and the conveyor 26 still moving, a second article 16 moves into the interior space of stand 12. The second article 16 enters the interior of stand 12 in the same manner as the first article 16. The sensor 20 will detect that a second article 16 has entered stand 12. The sensor 20 will detect when the second article 16 is directly below and in alignment with the first article 16. When the second article 16 is directly below the first article 16, the lift 44 will engage and extend to place the first article 16 on top of the second article 16, while simultaneously the pair of opposing arms 58 disengages to release the second article 16.

The first article 16 will be stacked directly and in alignment with the second article 16 such that the bottom of the first article 16 is in flush, planar engagement with the top surface of the second article 16. The stacked articles 16 will then be stacked on the belt 28 of the conveyor 26 and free from the engagement of the stacker 14. The conveyor 26 will then move the stacked articles 16 from stand 12. The stacked articles 16 will exit stand 12 the opposite side from which they entered by means of the belt 28 of the conveyor 26.

While this example of the operation of system 10 involves stacking a first article 16 on top of a second article 16, any other number of articles 16 is hereby contemplated for use. For example, a third article 16 may be stacked on the second article 16, a fourth article 16 may be stacked, and so on.

Alternative Operation: In an alternative embodiment, system 10 does not use a conveyor 26 to move article 16. Instead, in this alternative embodiment, system 10 would move to first article 16, engage the first article 16 in a similar manner as mentioned herein, before moving on to second article 16 and stacking the articles 16. In this embodiment, the functions of stacker 14 and other features would be similar to the operation above but the system 10 would move on to article 16.

One example of this type of embodiment may be that stand 12 has a motorized base and is capable of moving system 10 and sensing the presence of articles 16 by having a plurality of sensors 20 or a lidar system. In this embodiment, stand 12 may be able to move stacker 14 about a warehouse or other area to perform stacking functions. Additionally, system 10 may not require a stand 12, but instead have a base or other operation to move stacker 14.

Alternative Operation: In an alternative embodiment, system 10 was designed to stack two standard egg cartons 16 that have an attached and closed lid. This process can be done using an existing conveyor 26. In this arrangement, system 10 is added to an existing conveyor 26, and utilities, such as electrical supply, are brought to system 10 at any desired location along the conveyor 26 line. Additionally, the conveyor's 26 start/stop function is wired through system 10 so that system 10 can stop the conveyor 26 in the event of a jam or other required stop, such as an article 16 blocking the sensor 20 for a prolonged period of time.

In this arrangement, the egg carton 16 should be consistently supplied on the conveyor 26 line in parallel orientation with the conveyor 26. In other words, a standard egg carton 16 is elongated such that the egg carton 16 is a rectangle when viewed from the top. The egg carton 16 should be placed on the conveyor 26 and fed through system 10 long-ways and centered on the conveyor 26 with enough gap between each egg carton 16 so that system 10 has adequate time to advance through each cycle and properly stack the two egg cartons 16 on top of each other.

The egg carton 16 enters system 10 and the pair of opposing arms 58 are at the outer position. The sensor 20 detects the egg carton 16 when the egg carton 16 enters system 10. After a predetermined time, the PLC 98 will activate the pair of opposing arms 58 which will clamp the egg carton 16. The lift 44 will then lift the pair of opposing arms 58, and the clamped egg carton 16, upwards, high enough for a second egg carton 16 to move underneath the clamped egg carton 16. The second carton 16 will enter system 10. The second egg carton 16 will be detected by sensor 20. After a predetermined time, the PLC 98 will activate and the lift 44 will lower the clamped egg carton 16 on top of the second egg carton 16 while the second egg carton 16 is still in motion. This unique ability of system 10 to stack an article 16, such as an egg carton 16, on top of a second article 16 without ever stopping the conveyor 26 allows for high volume stacking, which is desirable in today's fast paced industry.

Bypass Option: In an alternative embodiment, system 10 includes a bypass option. Bypass option is formed of any suitable size, shape and design and is configured to allow a user to raise system 10 a distance above the conveyor 26 such that larger articles 16, or articles 16 which are undesired to be stacked simply pass through system 10 without any interaction with system 10. Bypass option can be activated by a switch such that when the bypass switch is activated, the stacker 14 is automatically and mechanically lifted out of the way of articles 16 moving along the conveyor 26.

### Benefits of System:

From the above discussion and the accompanying drawings and claims it will be appreciated that the system 10 and operation of the system 10 to stack articles 16 as presented offers many advantages over the prior art. That is, the system 10 presented is easy to use, is efficient, is simple in design, is inexpensive, has a minimum number of parts, has an intuitive design, provides for efficient stacking without damaging articles 16, provides improved functionality, has improved accuracy, has a minimum number of buttons, provides for fast operation, utilizes standard parts and components where possible, among countless other objectives, features, and advantages.

It will be appreciated by those skilled in the art that other various modifications could be made to the system 10 without parting from the spirit and scope of this disclosure. All such modifications and changes fall within the scope of the claims and are intended to be covered thereby. It should be understood that the examples and embodiments described herein are for illustrative purposes only and that various modifications or changes in light thereof will be suggested to persons skilled in the art and are to be included within the spirit and purview of this disclosure.

### REFERENCE NUMERALS

10—System
12—Stand
14—Stacker
16—Article (A first article or a second article)
18—Control Cabinet
20—Sensor
22—Pneumatic System
24—Control System
26—Conveyor
28—Belt
30—Post
32—Lintel
34—Foot
36—Pulley
38—Lift Controller Plate
40—Stacker Support
42—Upper Portion (of Stacker)
44—Lift
46—Lift Controller
48—Lift Plate
50—Lift Cylinder
52—Lift Attachment
54—Calibration features
56—Lower Portion (of Stacker)
58—Pair of Opposing Arms
60—Arm Controller
62—Arm Attachment
64—Arm Cylinder
66—Arm Plate
68—Arm Assembly
70—Arm Spacer
72—Upper Arm
74—Lower Arm
76—Photoeye
78—Grip
80—Regulator
82—Regulator Support
84—Regulator Conduit
86—Regulator Attachment
88—Coil (of Lift Controller)
90—Solenoid Valve (of Lift Controller)
92—Coil (of Arm Controller)
94—Solenoid Valve (of Arm Controller)
96—Air Cylinder
98—Programmable Logic Controller
100—Cabinet Plate
102—Cabinet Support
104—Power Switch
106—Plurality of switches
108—Buzzer
110—Openings
112—Door
114—Conduit
116—Wire
118—Main Disconnect Switch
120—Circuit Breaker
122—Emergency Stop
124—Power Supply
126—Alarm Buzzer
128—Stop Conveyor Relay
130—Conveyor Emergency Stop
132—On/Off Switch
134—CPU
136—Stop Conveyor Relay Coil
138—Stop Conveyor Relay Solenoid
140—Article Raise Solenoid Valve
142—Article Clamp Solenoid Valve
144—Alarm Lamp
146—Article Presence Sensor
148—Article Moved Down Switch
150—Up Position Switch
152—Down Position Switch
154—Arm 1 Clamped Switch
156—Arm 2 Clamped Switch
158—Safety Door Open Switch
160—On/Off Switch Reset
162—Entrance Jam Sensor
164—Bypass Switch
166—First Upstream Conveyor Sensor
168—Second Upstream Conveyor Sensor

What is claimed:

1. A pack stacker system, comprising
a stacker (14) having a lift (44), an arm controller (60), and a pair of opposing arms (58), the lift (44) being configured to vertically raise and lower the arm controller (60) and the pair of opposing arms (58), the arm controller (60) being configured to control the pair of opposing arms (58) to move horizontally towards and away from each other to capture and release an article (16);
a stand (12) supporting the stacker (14);
a sensor (20) configured to trigger movement of the pair of opposing arms (58) and the lift (44); and
a control cabinet (18) housing a pneumatic system (22) and a control system (24), wherein the pneumatic system (22) and the control system (24) are configured to provide pressurized air to the lift (44) and the arm controller (60).

2. The pack stacker system of claim 1, further comprising:
a conveyor passing between a pair a vertical posts of the stand.

3. The pack stacker system of claim 1, wherein the lift includes a lift controller controlling a lift cylinder.

4. The pack stacker system of claim 1, wherein the lift includes a lift controller housing and a lift cylinder, the lift controller housing a solenoid valve and a coil which enables control of the lift cylinder.

5. The pack stacker system of claim 1, wherein the arm controller includes at least one arm cylinder configured to move at least one arm of the pair of opposing arms.

6. The pack stacker system of claim 1, further comprising:
a lift plate connected to the lift and the arm controller.

7. The pack stacker system of claim 1, further comprising:
a lift plate between the lift and the arm controller, wherein the lift plate is connected to both the lift and arm controller such that raising and lowering of the lift plate by the lift raises and lowers the arm controller.

8. The pack stacker system of claim 1, wherein the pneumatic system includes a regulator configured to apply pressure to the lift and the arm controller.

9. The pack stacker system of claim 1, further comprising:
at least one grip on at least one arm of the at least one pair of arms.

10. The pack stacker system of claim 1, wherein the stand includes at least one foot configured to adjust a height of the stand.

11. A method of stacking a first article on a second article, the method comprising:
moving the first article into a stand;
lowering a pair of arms towards the first article;
sandwiching the first article between the pair of arms by moving the pair of arms towards one another;
lifting the first article;
moving the second article into the stand;
lowering the pair of arms to place the first article on the second article;
moving the pair of arms away from one another to release the first article.

12. The method of claim 11, wherein moving the first article into the stand includes moving a conveyor belt between two vertical posts of the stand.

13. The method of claim 11, wherein lowering the pair of arms towards the first article includes extending a lift cylinder to lower the pair of arms.

14. The method of claim 11, wherein sandwiching the first article between the pair of arms includes retracting an arm cylinder.

15. The method of claim 11, wherein lifting the first article includes retracting a lift cylinder.

16. The method of claim 11, wherein moving the second article into the stand includes moving the conveyor belt between vertical posts of the stand.

17. The method of claim 11, wherein lowering the pair of arms to place the first article on the second article includes extending a lift cylinder.

18. The method of claim 11, wherein moving the pair of arms away from one another to release the first article includes extending an arm cylinder.

19. A pack stacker system, comprising:
a stand comprised of at least two vertical posts;
a conveyer passing through the at least two vertical posts;
a stacker having a lift controller and an arm controller, the lift controller being configured to control a lift cylinder, the arm controller being configured to control a pair of opposing arms, wherein the lift cylinder is configured to raise and lower the arm controller and the pair of opposing arms and the arm controller is configured to move the pair of opposing arms towards and away from each other;
a sensor configured to trigger movement of at least one of the pair of opposing arms and the lift.

20. The pack stacker system of claim 19, further comprising a pneumatic system configured to provide air to each of the lift cylinder and the arm controller.
